(19) United States
(12) Patent Application Publication
(10) Pub. No.: US 2018/0077028 A1
(43) Pub. Date: Mar. 15, 2018

(54) DETERMINING THE QUALITY OF A CAPACITY PROJECTION FROM A COMPUTING SYSTEM CAPACITY MANAGEMENT PRODUCT

(71) Applicant: CA, Inc., New York, NY (US)

(72) Inventors: David A. RICH, Ayer, MA (US); Alex ESTERKIN, Revere, MA (US); James B. MERCER, Millville, MA (US)

(73) Assignee: CA, Inc., New York, NY (US)

(21) Appl. No.: 15/263,653

(22) Filed: Sep. 13, 2016

(51) Int. Cl. H04L 12/24; G06F 17/30; H04L 12/26

(52) U.S. Cl. CPC H04L 41/147; H04L 41/145; H04L 43/08; G06F 17/30873

(57) ABSTRACT

Some embodiments disclosed herein are directed to a capacity management node having a processor and a memory coupled to the processor and comprising computer readable program code that when executed by the processor causes the processor to perform operations including determining, using historical metric data that is used to determine a performance metric projection corresponding to a network computing resource, a performance projection quality factor that indicates a reliability of the performance metric projection based on a plurality of data driven values and a plurality of user specified values that correspond to the plurality of data driven values.

### BACKGROUND

The present disclosure relates to computer systems, and in particular to controlling deployment of resources within a distributed computing system.

Distributed computing systems, sometimes also referred to as cloud computing systems, are used to provide services to electronic devices, which may be operated by end users. In a cloud computing system, the physical machine architecture is hidden from the end user. The physical machines can include servers, network storage devices, computing devices, network routers, network gateways, wireless/wired network interface devices, etc. However, because services are deployed on a physical machine architecture, which is hidden from end users, it can be managed, upgraded, replaced or otherwise changed by a system administrator (operator) without the end users being aware of or affected by the change.

In existing cloud and other distributed computing systems, resource planning may be performed to predict system and/or device capacity for future information technology initiatives. Current capacity management products may provide projections of performance metrics based on historical data. Information technology customers may rely on the projections to make planning decisions. However, the projections may only be as reliable as the underlying historical data and determining the quality of that historical data may be difficult.

### SUMMARY

Some embodiments disclosed herein are directed to a method of operating a capacity management node. Operations may include, for a performance metric projection that is determined using historical metric data corresponding to a network computing resource and that is collected at periodic time intervals over a data collection period, determining, using the historical metric data corresponding to the network computing resource and a user specified value, a performance projection quality factor that indicates a reliability of the performance metric projection.

In some embodiments, determining the performance projection quality factor comprises determining a plurality of data driven values using the historical metric data and calculating the performance projection quality factor using the plurality of data driven values and the user specified value. Some embodiments provide that determining the plurality of data driven values comprises receiving, from a data repository, the historical metric data that is stored therein, and determining a statistical value indicating a proportion of variance of the historical metric data and determining another one of the plurality of data driven values.

Some embodiments provide that determining the another one of the plurality of data driven values comprises determining a data coverage value that corresponds to a function of a quantity of historical metric data values that are expected for a time period and a quantity of historical metric data values that are received for the time period. In some embodiments, the data coverage value comprises a ratio of the quantity of historical metric data values that are received for the time period to the quantity of historical metric data values that are expected for the time period and the data coverage value is in a range from zero to one. Some embodiments provide that the data coverage value further comprises a recency factor that causes the data coverage value to vary as a function of an age of the data.

In some embodiments, determining the another one of the plurality of data driven values comprises determining a time period ratio value that corresponds to a function of a quantity of time intervals of historical metric data and a quantity of time intervals included in the performance metric projection. Some embodiments provide that the time period ratio value comprises a ratio of the quantity of time intervals of the historical metric data and the quantity of time intervals of historical data included in the performance metric projection and the time period ratio value is in a range from zero to one.

Some embodiments provide that determining the another one of the plurality of data driven values comprises determining two of the plurality of data driven values that include a data coverage value that corresponds to a function of a quantity of historical metric data values that are expected for a time period and a quantity of historical metric data values that are received for the time period and a time period ratio value that corresponds to a function of a quantity of time intervals of historical metric data and a quantity of time intervals included in the performance metric projection.

In some embodiments, determining the performance projection quality factor that indicates a reliability of the performance metric projection comprise determining a statistical value indicating a proportion of variance of the historical metric data, determining a data coverage value that corresponds to a function of a quantity of historical metric data values that are expected for a time period and a quantity of historical metric data values that are received for the time period, determining a time period ratio value that corresponds to a function of a quantity of time intervals of historical metric data and a quantity of time intervals included in the performance metric projection.

Some embodiments provide that determining the performance projection quality factor that indicates a reliability of the performance metric projection further comprises determining the performance projection quality factor as a weighted sum of the statistical value, the data coverage value and the time period ratio value.

In some embodiments, the user specified value comprises a plurality of weights that are each multiplied by a respective one of the statistical value, the data coverage value and the time period ratio value to determine the weighted sum. Some embodiments provide that the weighted sum is multiplied by a constant and divided by a sum of the plurality of weights and the performance projection quality factor includes a value in a range between zero and a value of the constant.

Some embodiments further include generating a user output that associates the performance projection quality factor with the performance metric projection.

Some embodiments of the present inventive concept are directed to a computer program product that includes a computer readable storage medium having computer readable program code embodied in the medium that when executed by a processor of a computer system causes the computer system to perform operations including, for a performance metric projection that is determined using historical metric data corresponding to a network computing resource and that is collected at periodic time intervals over a data collection period, determining, using the historical metric data corresponding to the network computing resource, a performance projection quality factor that indicates a reliability of the performance metric projection based on a plurality of data driven values determined using the historical metric data and a plurality of user specified values that correspond to the plurality of data driven values and generating a user output that associates the performance projection quality factor with the performance metric projection.

In some embodiments, the plurality of data driven factors comprise an r-squared statistical value indicating a proportion of variance of the historical metric data, a data coverage value that corresponds to a function of a quantity of historical metric data values that are expected for a time period and a quantity of historical metric data values that are received for the time period and a time period ratio value that corresponds to a function of a quantity of time intervals of historical metric data and a quantity of time intervals included in the performance metric projection.

Some embodiments provide that determining the performance projection quality factor that indicates a reliability of the performance metric projection further comprises determining the performance projection quality factor as a weighted sum of the statistical value, the data coverage value and the time period ratio value. In some embodiments, the plurality of user specified values that are each multiplied by a respective one of the statistical value, the data coverage value and the time period ratio value to determine the weighted sum.

In some embodiments, the weighted sum is multiplied by a constant and divided by a sum of the plurality of user specified values and the performance projection quality factor includes a value in a range between zero and a value of the constant.

Some embodiments of the present inventive concept are directed to a capacity management node that includes a processor and a memory coupled to the processor and comprising computer readable program code that when executed by the processor causes the processor to perform operations comprising determining, using historical metric data that is used to determine a performance metric projection corresponding to a network computing resource, a performance projection quality factor that indicates a reliability of the performance metric projection based on a plurality of data driven values and a plurality of user specified values that correspond to the plurality of data driven values.

In some embodiments, the plurality of data driven values comprise an r-squared statistical value indicating a proportion of variance of the historical metric data, a data coverage value that corresponds to a function of a quantity of historical metric data values that are expected for a time period and a quantity of historical metric data values that are received for the time period, and a time period ratio value that corresponds to a function of a quantity of time intervals of historical metric data and a quantity of time intervals included in the performance metric projection. Some embodiments provide that the plurality of user specified values are each multiplied by a respective one of the statistical value, the data coverage value and the time period ratio value to determine the weighted sum and the weighted sum is multiplied by a constant and divided by a sum of the plurality of user specified values.

It is noted that aspects described with respect to one embodiment may be incorporated in different embodiments although not specifically described relative thereto. That is, all embodiments and/or features of any embodiments can be combined in any way and/or combination. Moreover, other resource and/or capacity management nodes, distributed computing systems, methods, and/or computer program products according to embodiments will be or become apparent to one with skill in the art upon review of the following drawings and detailed description. It is intended that all such additional resource and/or capacity management nodes, distributed computing systems, methods, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a pictorial illustration of a distributed computer system that is configured as a data center according to some embodiments;

FIG. 2 is a block diagram of a capacity management node, used in a distributed computing system, that is configured according to some embodiments;

FIG. 3 is a block diagram of a distributed computing system that is configured according to some embodiments;

FIG. 4 is a capacity management node that is configured according to some embodiments;

FIGS. 5-9 are flowcharts that illustrate different operations for determining the quality of a capacity projection of a network computing resource according to some embodiments; and

FIG. 10 illustrates information that may be displayed to inform an operator of the quality of projections corresponding to a network computing resource according to some embodiments.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As disclosed herein, the quality of historical data used to make projections of performance metrics may affect the reliability of the projections. It may be beneficial to determine the quality of the data and/or the performance metric projection and to provide information regarding the data and/or the performance metric projection in an easy to understand interface and/or report.

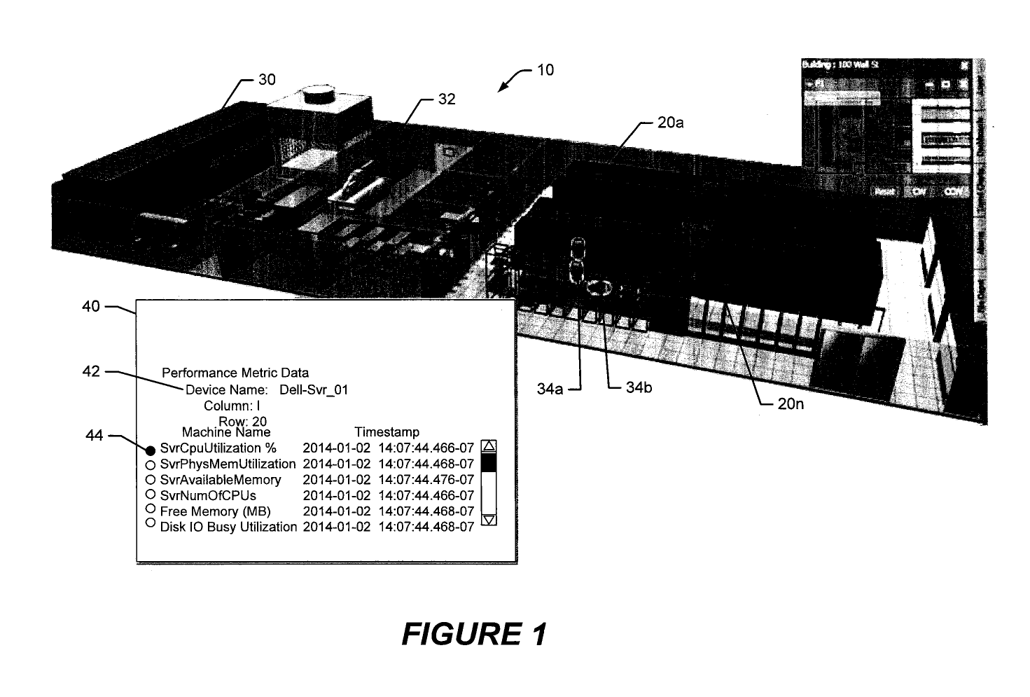

FIG. 1 is a block diagram of a distributed computer system that is configured as a data center 10 according to some embodiments. The data center 10 can include hundreds or thousands of data servers, which are mounted to physical racks 20a-20n arranged in rows for accessibility by operators. The data servers consume substantial amounts of electrical power from a power source 30, occupy significant amount of physical rack storage space of the data center 10, and require substantial cooling heat transfer by a cooling system 32 to remain within an acceptable operational temperature range. The electrical power, physical rack storage space, cooling, and other support systems are examples of infrastructure provided by the data center 10 to support operation of the data servers and that may be used in determining risk projections corresponding to network computing resources. As used herein, the term network computing resource may include but is not limited to data servers, data storage devices, network interfaces, switches, routers, network communication devices, and the like. In some embodiments, the data center 10 includes a capacity management node, which can also be mounted within one or more of the physical racks 20 or separate therefrom, and can operate according to various embodiments disclosed herein.

The data servers and associated network communication devices are example physical machines of the data center 10. The data servers perform computer operations that provide a plurality of guest virtual machines (VMs) within a plurality of VM clusters. Each VM cluster can include a plurality of guest VMs, and each VM cluster can reside on different data servers or may be distributed across more than one data server. For each of the guest VMs, a resource management node determines a productivity metric for the guest VM based on resources of the data server that are used by the guest VM.

In some further embodiments, the resource management node repeats these operations for each of the VM clusters. The infrastructure value may be determined based on electrical power consumption by the physical machine which is attributed to providing the guest VM. The infrastructure value may additionally or alternatively be determined based on physical rack storage space of the distributed computing system occupied by the physical machine which is attributed to providing the guest VM.

Some embodiments provide that a capacity management node may poll, or cause to be polled, a network computing resource, such as an individual data server and/or network communication device, to determine performance metric data corresponding to the network computing resource. The polling may be performed at a given time interval, the value of which may depend on the usage, type, and/or application of the network computing resource. For example, some embodiments provide that the polling is done at an interval that may include ranges of one or more seconds, hours, days and/or weeks. The polling may be performed by an application that is separate from the network computing resource and/or by an agent application that is within and/or on the network computing resource.

The performance metric data that is received responsive to the polling may be stored in a data repository, which can also be mounted within one or more of the physical racks 20 or separate therefrom. Embodiments provide that many different types of performance metric data may be collected and stored including CPU utilization, data transmission rates, latency, memory usage, percent bandwidth, internal temperature, electrical power usage, and/or data channel utilization, among others. [INVENTORS: Please add any other examples of data types.]

Some embodiments provide that the capacity management node may use historical metric data that was collected and stored to provide a risk projection corresponding to the specific network computing resource. In some embodiments, the risk projection may include one or more performance metric projections. Some embodiments provide that a risk projection value is a performance metric projection. The historical metric data and a user specified value may further be used to determine a performance projection quality factor that indicates a reliability of the performance metric projection.

In FIG. 1, a report 40 is displayed, on a display device of a data center terminal, that identifies the name 42 of one of the server devices and identifies the utilization of defined resources 44. The resource utilizations displayed can include server CPU utilization percentage, server physical memory utilization, server available memory, server number of CPUs, free memory, and/or disk input/output busy utilization. The report may further indicate if any of the resources are operating near defined limits (e.g., excessive server CPU utilization percentage is noted by the blackened circle).

A pictorial illustration of the data center 10 may also be displayed. The resource management node may display graphical alarm indications 34a and 34b at particular locations of the racks where the data center operator may want to remove or replace one of the server devices based on information provided by the resource management node according to one or more embodiments disclosed herein. These and other operations are explained in further detail below after the following explanation of an example capacity management node and distributed computing system in which the operations may be performed.

### Capacity Management Node of a Distributed Computing System

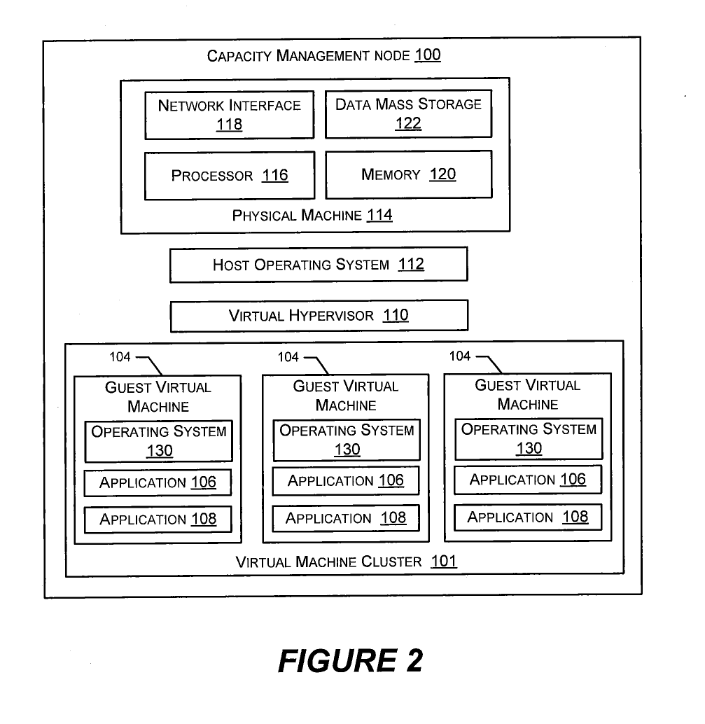

FIG. 2 is a block diagram of a capacity management node 100 of a distributed computing system that is configured according to some embodiments. Referring to FIG. 2, the capacity management node 100 includes a physical machine 114 that performs computer operations to provide one or more VM clusters 101. Each of the VM clusters includes a plurality of guest VMs 104. Each guest VM 104 runs a guest operating system 130 and a plurality of applications 106 and 108. The computing needs of users 102 (e.g., humans and/or other virtual/non-virtual machines) drive the functionality of the VM cluster 101 and guest VMs 104 thereof. A virtual hypervisor 110 can provide an interface between the VM cluster 101 and a host operating system 112 and allows multiple guest operating systems 130 and associated applications 106 and 108 to run concurrently. The host operating system 112 is responsible for the management and coordination of activities and the sharing of the computer resources of the physical machine 114.

The physical machine 114 may include, without limitation, network content servers (e.g., Internet website servers, movie/television programming streaming servers, application program servers), network storage devices (e.g., cloud data storage servers), network data routers, network gateways, communication interfaces, program code processors, data memories, display devices, and/or peripheral devices. The physical machine 114 may include computer resources such as: processor(s) 116 (e.g., central processing unit, CPU); network interface(s) 118; memory device(s) 120; data mass storage device(s) 122 (e.g., disk drives, solid state nonvolatile memory, etc.); etc. The processor(s) 116 is configured to execute computer program code from the memory device(s) 120, described below as a computer readable storage medium, to perform at least some of the operations disclosed herein.

Besides acting as a host for computing applications 106 and 108 that run on the physical machine 114, the host operating system 112 may operate at the highest priority level of the capacity management node 100, executing instructions associated with the physical machine 114, and it may have exclusive privileged access to the physical machine 114. The host operating system 112 creates an environment for implementing the VM cluster 101, which hosts the guest VMs 104. One host operating system 112 is capable of implementing multiple independently operating VM clusters 101 simultaneously.

The virtual hypervisor 110 (which may also be known as a virtual machine monitor or VMM) runs on the host operating system 112 and provides an interface between the VM clusters 101 and the physical machine 114 through the host operating system 112. The virtual hypervisor 110 virtualizes the computer system resources and facilitates the operation of the host guest VMs 104 and associated VM cluster 101. The virtual hypervisor 110 may provide the illusion of operating at a highest priority level to the guest operating system 130. However, the virtual hypervisor 110 can map the guest operating system's priority level to a priority level lower than a top most priority level. As a result, the virtual hypervisor 110 can intercept the guest operating system 130 operations, and execute instructions that require virtualization assistance. Alternatively, the virtual hypervisor 110 may indirectly emulate or directly execute the instructions on behalf of the guest operating system 130. Software steps permitting indirect interaction between the guest operating system 130 and the physical machine 114 can also be performed by the virtual hypervisor 110.

The VMs 104 present a virtualized environment to the guest operating systems 130, which in turn provide an operating environment for the applications 106 and 108, and other software constructs.

### Distributed Computing System

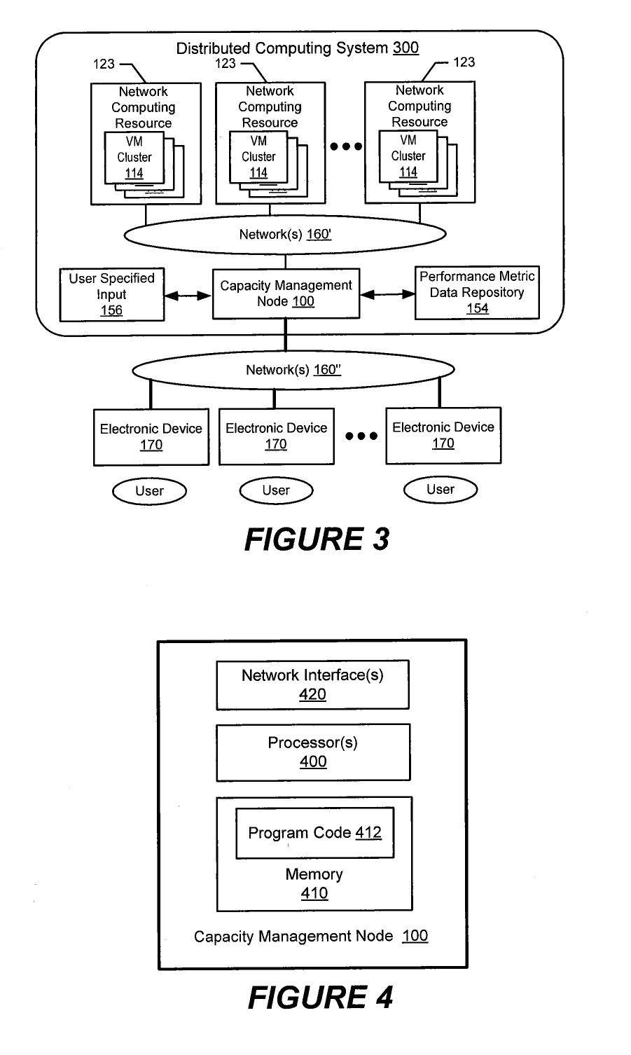

FIG. 3 is a block diagram of a distributed computing system 300 that is configured according to some embodiments. Referring to FIG. 3, the distributed computing system 300 receives requests from electronic devices 170a-170n via one or more networks 160″ for processing. The electronic devices 170a-170n may be operated by end-users. The distributed computing system 300 includes a capacity management node 100 and a performance metric data repository 154. The electronic devices 170a-170n may include, but are not limited to, desktop computers, laptop computers, tablet computers, wireless mobile terminals (e.g., smart phones), gaming consoles, networked televisions with on-demand media request capability. The capacity management node 100 may be configured as described herein regarding FIG. 2. For some distributed computing systems 300, the number of capacity management nodes 100 can number more than a hundred or thousand and the number of electronic devices 170 can number more than a thousand or hundred thousand.

Some embodiments provide that performance metric data corresponding to the network computing resources 123 may be collected and stored in the performance metric data repository 154. Some embodiments provide that the capacity management node 100 causes the performance metric data to be collected and stored, however, such embodiments are non-limiting as a different node and/or module may perform all or a portion of the data collection from the network computing resources 123.

The capacity management node 100 may use performance metric data that is stored in the performance metric data repository 154 to generate a performance metric projection corresponding to one or more performance metrics based on the historical metric data. The performance metric projections may be used as inputs for making planning decisions regarding the computing system.

The capacity management node 100 may further operate to generate a performance projection quality factor that provides a value representing the quality of the performance metric projection based on historical metric data that is stored in the performance metric data repository 154. For example, a performance projection quality factor may range from 0 to 100 such that the higher the value, the higher the confidence in the performance metric projection. In this example, a performance metric projection having a performance projection quality factor that is greater than 90 may be used with greater confidence that the underlying data is sufficient to justify and/or rely on the performance metric projection. In contrast, a performance metric projection having a performance projection quality factor of less than 10 may be dismissed or deemed as only having marginal value based on a low confidence that the underlying data is sufficient to justify and/or rely on the performance metric projection.

In addition to data driven factors derived from the historical metric data from the performance metric data repository 154, the performance projection quality factor may also be generated based on one or more user specified inputs 156. For example, some embodiments provide that the performance projection quality factor is determined by generating multiple different data driven values based on the historical metric data from the performance metric data repository 154. In such embodiments, the user specified inputs 156 may include weighting factors that correspond to each of the multiple data driven values. Some embodiments provide that the weighting factors may range from 0 to 1. The weighting factors may have default values of 1, but may be adjusted by a user based on user-specific applications and/or decisions regarding the performance projection quality factor. For example, a user may determine that one of the data driven factors in the performance projection quality factor is not applicable to the particular circumstance. In such cases, the user may set the weighting factor corresponding to that data driven factor to be substantially lower than the other weighting factors. Some embodiments provide that the capacity management node 100 may provide a user interface that is configured to receive the user specified inputs.

### Example Capacity Management Node

Reference is now made to FIG. 4, which is a block diagram of a capacity management node 100 that is configured to perform the operations of one of more of the embodiments disclosed herein. The capacity management node 100 can include one or more network interfaces 420, one or more processors 400 (referred to as “processor” for brevity), and one or more memories 410 (referred to as “memory” for brevity) containing program code 412.

The processor 400 may include one or more data processing circuits, such as a general purpose and/or special purpose processor (e.g., microprocessor and/or digital signal processor) that may be collocated or distributed across one or more networks. The processor 400 is configured to execute program code 412 in the memory 410, described below as a computer readable medium, to perform some or all of the operations for one or more of the embodiments disclosed herein.

As explained above, a distributed computing system (e.g., data center) can include hundreds or thousands of physical machines (e.g., data servers). The physical machines perform computer operations that provide a plurality of guest VMs within a plurality of VM clusters. Each VM cluster can include a plurality of guest VMs. Each of the VM's and/or VM clusters may be and/or be supported by a computing network resource.

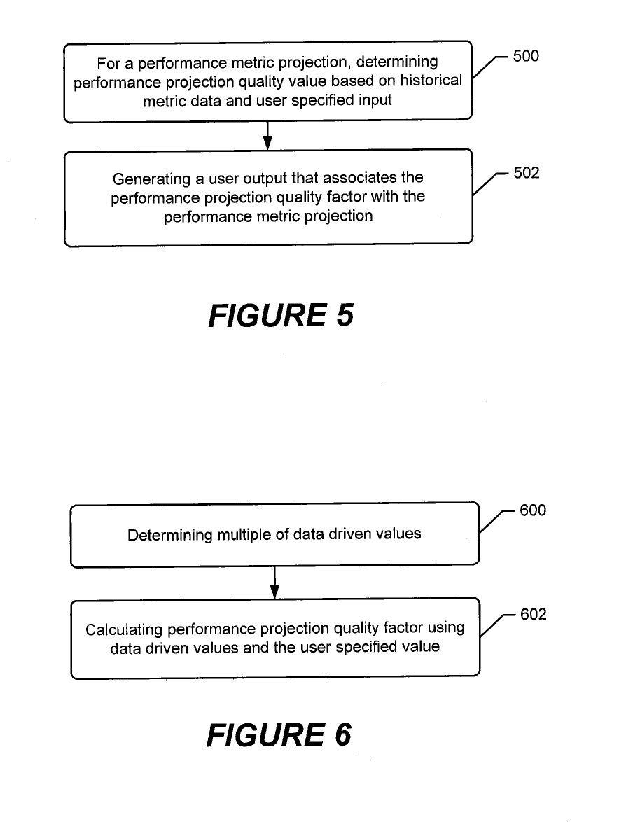

FIGS. 5-9 illustrate operations that can be performed by a capacity management node 100. Referring to FIG. 5, for any of the computing network resources, the capacity management node 100 determines (block 500) a performance projection quality factor of a performance metric projection. The performance projection quality factor is based on historical metric data that may be provided from the performance metric data repository 154 and user specified inputs 156. Some embodiments provide that the user specified inputs 156 include a user specified value that is a weighting factor corresponding to a data driven value that is determined from the historical metric data.

The capacity management node 100 may generate a user output that includes one of more of the performance metric projections and performance projection quality factors that correspond to each of the one or more performance metric projections. For example, the user output may include a graphical representation of risk projections corresponding to one or more network computing resources. The risk projections may correspond to one or more different performance metrics, such as, projected utilization, among others.

In some embodiments, individual values for the risk projections may be provided for one or more time future time periods and/or intervals thereof. For example, a risk projection may be provided for each month of the future 12 months. The risk projection may be a numerical value that indicates a risk projection and/or an identifier indicates the risk projection. For example, the risk projection identifier may include an alphabetic rating such as “A”, “B”, “C” or “F”, a color code such as green, yellow or red, and/or a condition such as “Pass” or “Fail”. Additionally, for each performance metric projection and/or for each computing network resource, a performance projection quality factor may be displayed. In this manner, a user may determine how much confidence to place in the performance metric projection.

Reference is now made to FIG. 6, which illustrates operations for determining the performance projection quality value according to some embodiments. Some embodiments provide that the performance projection quality factor is determined by determining multiple different data driven values using the historical metric data stored in the performance metric data repository 154 (block 600). The performance projection quality factor may be calculated using the multiple data driven values and the user specified value (block 602). In some embodiments, the user specified value may include a default value that the user may determine not to adjust. As used herein the user specified value may include a value that may be changed based on a user's input even in circumstances in which the user does not provide an input for changing the value.

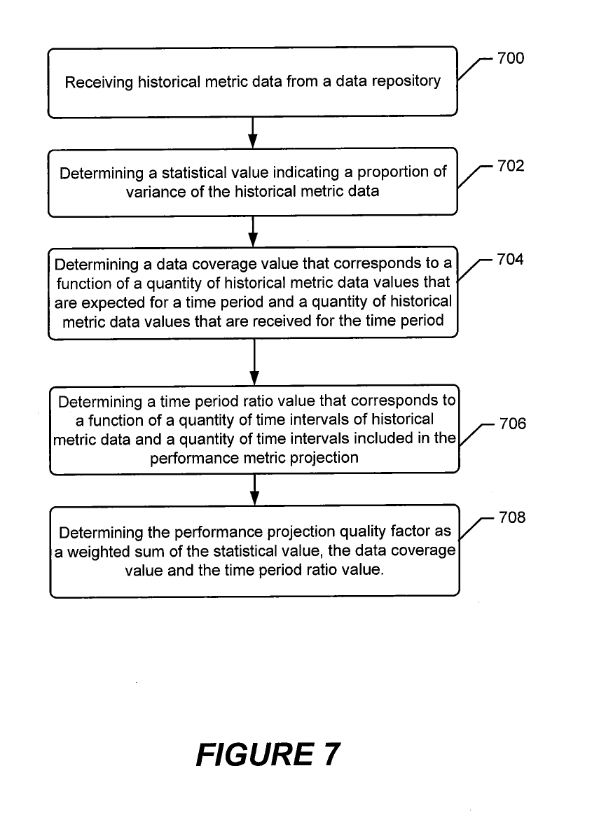

Reference is now made to FIG. 7, which illustrates operations for determining the multiple different data driven values in Block 600 above. Operations may include receiving, from a data repository, the historical metric data that is stored therein (block 700). For example, some embodiments provide that the historical metric data is stored in the performance metric data repository 154. In some embodiments, the performance metric data repository 154 be a single data storage repository, while some other embodiments provide that the performance metric data repository 154 is a distributed data repository provisioned in multiple different data storage repositories and/or instances thereof.

Determining the data driven values may include determining a statistical value that indicates a proportion of variance of the historical metric data (block 702). For example, some embodiments provide that the capacity management node may generate a data driven value using linear regression based on the historical metric data. For example, a least squares statistical approach may provide a coefficient of determination that represents how well the historical metric data is correlated. In some embodiments, the statistical value may be an R² value that indicates the proportion of the variance in the dependent variable that is predictable from the independent variable. Some embodiments provide that the statistical value is in a range from 0 to 1 in which a value of 1 indicates that the historical metric data is highly correlated and a value of 0 indicates that the historical metric data is uncorrelated.

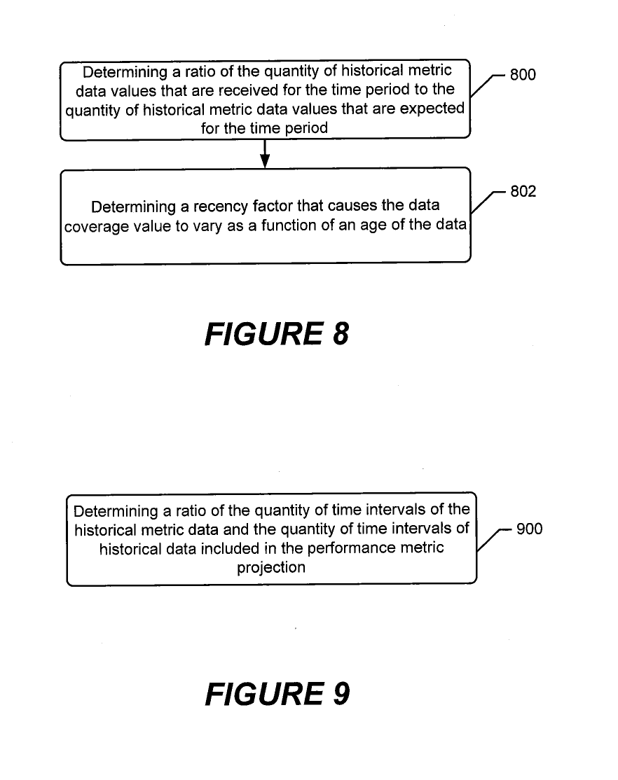

Determining the data driven values may include determining a data coverage value that corresponds to a function of a quantity of historical metric data values that are expected for a time period and a quantity of historical metric data values that are received for the time period (block 704). Briefly referring to FIG. 8, in some embodiments, the data coverage value may be determined as a ratio of the quantity of historical metric data values that are received for the time period to the quantity of historical metric data values that are expected for the same time period (block 800). For example, the data coverage value may be in a range from 0 to 1 in which the data coverage value of 0 indicates that none of the expected data is received and the data coverage value of 1 in which all of the expected data is received.

Some embodiments further provide that the data coverage value includes a recency factor that causes the data coverage value to vary as a function of the age of the data within the sample period (block 802). For example, some embodiments provide that the ratio of the quantity of historical metric data values that are received to the quantity of historical metric data values that are expected is weighted by the recency factor. The recency factor may be inversely proportional to the number of days since the date of the metric so that the most recent data has a higher weight than older less recent metric data. By way of example, if half of the expected historical metric data values were received then the ratio would be 0.5. If the received data includes the most recent data then the weighted ratio would be greater than 0.5 whereas if the received data does not include the most recent data then the weighted ratio would be less than 0.5.

Referring back to FIG. 7, determining the data driven values may include determining a time period ratio value that corresponds to a function of a quantity of time intervals of historical metric data and a quantity of time intervals included in the performance metric projection (block 706). Briefly referring to FIG. 9, determining the time period ratio value includes determining a ratio of the quantity of time intervals of the historical metric data and the quantity of time intervals of historical data included, in the performance metric projection (block 900). In some embodiments, the time period ratio value is in a range from zero to one.

In the context of a projection corresponding to a number of days, the time period ratio value may be determined as the ratio of the number of days of historical metric data to the number of days into the future that the performance metric projection will occur. For example, the number of days of historical metric data may be determined as the number of days from the first days of data to the time the performance metric projection is determined.

Referring back to FIG. 7 determining the performance projection quality factor that indicates a reliability of the performance metric projection further comprises determining the performance projection quality factor as a weighted sum of the statistical value, the data coverage value and the time period ratio value (block 708). In some embodiments, the user specified value includes weights corresponding to each of the statistical value, the data coverage value and the time period ratio value to determine a weighted sum.

In some embodiments, the range of the performance projection quality factor may be from 0 to a maximum value. For example, a range maximum value may be set as 100. In such embodiments, the weighted sum may be normalized to the range by multiplying the weighted sum by the maximum value (e.g., 100) and dividing the value by a sum of weights from the user input values. An example formula for determining the performance projection quality factor follows:

QF is 100*((A*RSQ)+(B*DCF)+(C*TPR))/(A+B+C),

in which QF is the performance projection quality factor, RSQ is the statistical value, DCF is the data coverage value, TPR is the time period ratio, and A, B and C are weighting factors from the user specified inputs. Some embodiments provide that the weighting factors are non-negative numbers.

By virtue of the operations described herein, a single value (performance projection quality factor) may be generated that indicates a level of confidence corresponding to a performance metric projection. The performance projection quality value may be tuned for specific circumstances, goals and/or environments by providing a data driven approach that can be configured by a user.

Determining and Displaying Risk Projections with Performance Projection Quality Factors

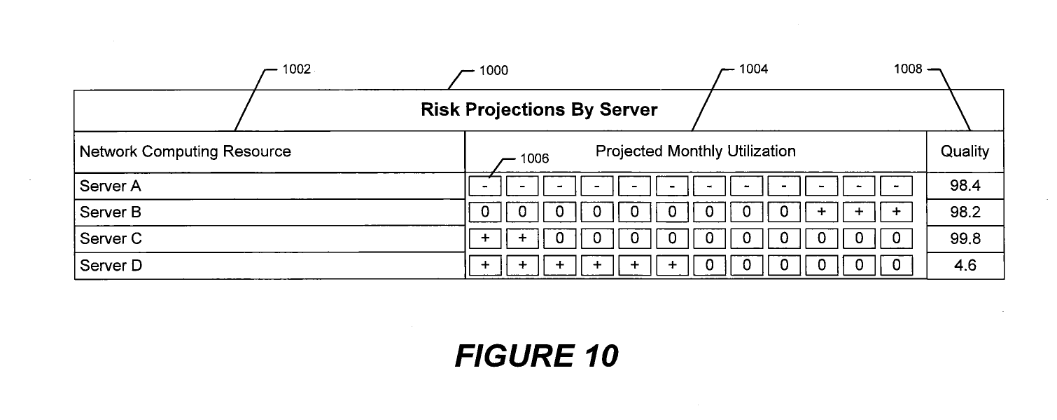

FIG. 10 illustrates information that may be displayed to inform an operator regarding risk projections corresponding to different network computing resources. The risk projections in the present example include risk projections corresponding to a monthly utilization metric of the different computing network resources. The display 1000 may provide information such as an identification of the network computing resource in column 1002, an identification of the performance metric projection in column 1004, individual performance metric projections 1006 and performance projection quality values in column 1008.

As illustrated, the individual performance metric projections 1006 may be provided as symbols that provide a general indication of the projection. For example, the minus sign “−” may indicate a poor risk projection for that time interval, the zero “0” may indicate a neutral risk projection for that time interval and a plus sign “+” may indicate a favorable risk projection for that time interval.

The performance projection quality factor 1008 in the illustrated example is a value in a range from 0 to 100. The higher that the value is, the better the quality and thus the more reliable the risk projection is. In the illustrated example, the risk corresponding to the projected monthly utilization 1006 for the Server A is poor for every month projected. However, the performance projection quality value corresponding to the projected monthly utilization for Server A is 98.4, which indicates to the user that the risk projection may be considered as reliable. In contrast, the risk corresponding to the projected monthly utilization 1006 for the Server D is favorable for the first six months and neutral for the last six months of the projection period. However, the performance projection quality value corresponding to the projected monthly utilization for Server D is 4.6, which indicates to the user that the risk projection may be considered as unreliable.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of operating a capacity management node comprising:
for a performance metric projection that is determined using historical metric data corresponding to a network computing resource and that is collected at periodic time intervals over a data collection period, determining, using the historical metric data corresponding to the network computing resource and a user specified value, a performance projection quality factor that indicates a reliability of the performance metric projection; and
using the performance projection quality factor to manage the network computing resource.

2. The method according to claim 1, wherein determining the performance projection quality factor comprises:
determining a plurality of data driven values using the historical metric data; and
calculating the performance projection quality factor using the plurality of data driven values and the user specified value.

3. The method according to claim 2, wherein determining the plurality of data driven values comprises:
receiving, from a data repository, the historical metric data that is stored therein; and
determining a statistical value indicating a proportion of variance of the historical metric data; and
determining another one of the plurality of data driven values.

4. The method according to claim 3, wherein determining the another one of the plurality of data driven values comprises determining a data coverage value that corresponds to a function of a quantity of historical metric data values that are expected for a time period and a quantity of historical metric data values that are received for the time period.

5. The method according to claim 4, wherein the data coverage value comprises a ratio of the quantity of historical metric data values that are received for the time period to the quantity of historical metric data values that are expected for the time period, and
wherein the data coverage value is in a range from zero to one.

6. The method according to claim 5, wherein the data coverage value further comprises a recency factor that causes the data coverage value to vary as a function of an age of the data.

7. The method according to claim 3, wherein determining the another one of the plurality of data driven values comprises determining a time period ratio value that corresponds to a function of a quantity of time intervals of historical metric data and a quantity of time intervals included in the performance metric projection.

8. The method according to claim 6, wherein the time period ratio value comprises a ratio of the quantity of time intervals of the historical metric data and the quantity of time intervals of historical data included in the performance metric projection, and
wherein the time period ratio value is in a range from zero to one.

9. The method according to claim 3, wherein determining the another one of the plurality of data driven values comprises determining two of the plurality of data driven values that include a data coverage value that corresponds to a function of a quantity of historical metric data values that are expected for a time period and a quantity of historical metric data values that are received for the time period and a time period ratio value that corresponds to a function of a quantity of time intervals of historical metric data and a quantity of time intervals included in the performance metric projection.

10. The method according to claim 1, wherein determining the performance projection quality factor that indicates a reliability of the performance metric projection comprises:
determining a statistical value indicating a proportion of variance of the historical metric data;
determining a data coverage value that corresponds to a function of a quantity of historical metric data values that are expected for a time period and a quantity of historical metric data values that are received for the time period;
determining a time period ratio value that corresponds to a function of a quantity of time intervals of historical metric data and a quantity of time intervals included in the performance metric projection.

11. The method according to claim 10, wherein determining the performance projection quality factor that indicates a reliability of the performance metric projection further comprises determining the performance projection quality factor as a weighted sum of the statistical value, the data coverage value and the time period ratio value.

12. The method according to claim 10, wherein the user specified value comprises a plurality of weights that are each multiplied by a respective one of the statistical value, the data coverage value and the time period ratio value to determine the weighted sum.

13. The method according to claim 12, wherein the weighted sum is multiplied by a constant and divided by a sum of the plurality of weights, and
wherein the performance projection quality factor includes a value in a range between zero and a value of the constant.

14. The method according to claim 1, further comprising generating a user output that associates the performance projection quality factor with the performance metric projection.

15. A computer program product comprising:
a computer readable storage medium having computer readable program code embodied in the medium that when executed by a processor of a computer system causes the computer system to perform operations comprising:
for a performance metric projection that is determined using historical metric data corresponding to a network computing resource and that is collected at periodic time intervals over a data collection period, determining, using the historical metric data corresponding to the network computing resource, a performance projection quality factor that indicates a reliability of the performance metric projection based on a plurality of data driven values determined using the historical metric data and a plurality of user specified values that correspond to the plurality of data driven values; and
generating a user output that associates the performance projection quality factor with the performance metric projection.

16. The computer program product according to claim 15, wherein the plurality of data driven factors comprise:
an r-squared statistical value indicating a proportion of variance of the historical metric data;
a data coverage value that corresponds to a function of a quantity of historical metric data values that are expected for a time period and a quantity of historical metric data values that are received for the time period; and
a time period ratio value that corresponds to a function of a quantity of time intervals of historical metric data and a quantity of time intervals included in the performance metric projection.

17. The computer program product according to claim 16, wherein determining the performance projection quality factor that indicates a reliability of the performance metric projection further comprises determining the performance projection quality factor as a weighted sum of the statistical value, the data coverage value and the time period ratio value,
wherein the plurality of user specified values that are each multiplied by a respective one of the statistical value, the data coverage value and the time period ratio value to determine the weighted sum.

18. The computer program product according to claim 17, wherein the weighted sum is multiplied by a constant and divided by a sum of the plurality of user specified values, and wherein the performance projection quality factor includes a value in a range between zero and a value of the constant.

19. A capacity management node comprising:
a processor; and
a memory coupled to the processor and comprising computer readable program code that when executed by the processor causes the processor to perform operations comprising:
determining, using historical metric data that is used to determine a performance metric projection corresponding to a network computing resource, a performance projection quality factor that indicates a reliability of the performance metric projection based on a plurality of data driven values and a plurality of user specified values that correspond to the plurality of data driven values.

20. The capacity management node according to claim 19, wherein the plurality of data driven values comprise:
an r-squared statistical value indicating a proportion of variance of the historical metric data;
a data coverage value that corresponds to a function of a quantity of historical metric data values that are expected for a time period and a quantity of historical metric data values that are received for the time period; and
a time period ratio value that corresponds to a function of a quantity of time intervals of historical metric data and a quantity of time intervals included in the performance metric projection,
wherein the plurality of user specified values are each multiplied by a respective one of the statistical value, the data coverage value and the time period ratio value to determine the weighted sum, and
wherein the weighted sum is multiplied by a constant and divided by a sum of the plurality of user specified values.
